(19) United States
(12) Patent Application Publication
(10) Pub. No.: US 2022/0362854 A1
(43) Pub. Date: Nov. 17, 2022

(54) THREE-DIMENSIONAL OBJECT MANUFACTURING METHOD

(71) Applicant: TOYOTA JIDOSHA KABUSHIKI KAISHA, Toyota-shi (JP)

(72) Inventors: Yuto TANAKA, Nagoya-shi (JP); Ryo WATANABE, Toyota-shi (JP); Masataka YASUI, Toyota-shi (JP)

(73) Assignee: TOYOTA JIDOSHA KABUSHIKI KAISHA, Toyota-shi (JP)

(21) Appl. No.: 17/719,978

(22) Filed: Apr. 13, 2022

(30) Foreign Application Priority Data
May 14, 2021 (JP) 2021-082277

(51) Int. Cl. B22F 10/47; B33Y 10/00; B33Y 40/20; B22F 10/28; B23K 26/342

(52) U.S. Cl. CPC B22F 10/47; B33Y 10/00; B33Y 40/20; B22F 10/28; B23K 26/342

(57) ABSTRACT

A three-dimensional object manufacturing method includes a molding step of molding a first three-dimensional object, a second three-dimensional object and a first support part for coupling the first and second three-dimensional objects at mutually different positions on a base plate by an additive manufacturing, and a separation step of separating the first three-dimensional object, the second three-dimensional object, the first support part and the base plate from each other. In the separation step, the first and second three-dimensional objects are separated from each other by dividing the first support part after at least one of the first and second three-dimensional objects is separated from the base plate.

### CROSS REFERENCE TO RELATED APPLICATIONS

This application claims priority to Japanese Patent Application No. 2021-082277, filed May 14, 2021, the disclosure of which is incorporated by reference herein in its entirety.

### BACKGROUND

### Field

The present disclosure relates to a three-dimensional object manufacturing method.

### Related Art

JP2020-164890A discloses a method for molding an object on a base plate by an additive manufacturing.

Patent Literature 1: JP2020-164890A

Many objects may be efficiently manufactured by forming a plurality of objects on a base plate at once. However, in the case of molding the plurality of objects on the base plate at once, there is a possibility that the objects contact each other to be damaged in separating the objects from the base plate.

### SUMMARY

According to one aspect of the present disclosure, a three-dimensional object manufacturing method is provided. This three-dimensional object manufacturing method includes a molding step of molding a first three-dimensional object, a second three-dimensional object and a first support part for coupling the first and second three-dimensional objects at mutually different positions on a base plate by an additive manufacturing, and a separation step of separating the first three-dimensional object, the second three-dimensional object, the first support part and the base plate from each other. In the separation step, the first and second three-dimensional objects are separated from each other by dividing the first support part after at least one of the first and second three-dimensional objects is separated from the base plate.

### BRIEF DESCRIPTION OF DRAWINGS

FIG. 1 is a sectional view schematically showing a schematic configuration of a additive manufacturing apparatus of a first embodiment;

FIG. 2 is a flow chart showing contents of a three-dimensional object manufacturing method of the first embodiment;

FIG. 3 is a diagram showing a state of a molding step of the first embodiment;

FIG. 4 is a perspective view showing examples of three-dimensional objects and support parts of the first embodiment;

FIG. 5 is a first diagram showing a state of a separation step of the first embodiment;

FIG. 6 is a second diagram showing a state of the separation step of the first embodiment;

FIG. 7 is a diagram showing a state of a separation step of a comparative example;

FIG. 8 is a perspective view showing examples of three-dimensional objects and support parts of a second embodiment; and

FIG. 9 is a side view showing examples of three-dimensional objects and support parts of a third embodiment.

### DETAILED DESCRIPTION

### A. First Embodiment

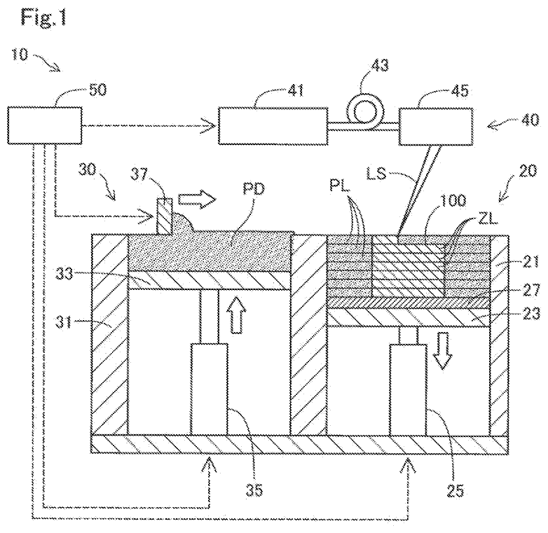

FIG. 1 is a sectional view schematically showing a schematic configuration of a additive manufacturing apparatus 10 used in a method for manufacturing three-dimensional objects 100 in a first embodiment. In the present embodiment, the additive manufacturing apparatus 10 includes a molding unit 20, a powder layer forming unit 30, a laser emitting unit 40 and a control unit 50. In the present embodiment, the additive manufacturing apparatus 10 molds the three-dimensional objects 100 by an additive manufacturing of the powder bed fusion type, more specifically by an additive manufacturing of the SLM (Selective Laser Melting) type. In the following description, the three-dimensional object 100 may be simply called an object 100.

The molding unit 20 includes a molding container 21, a molding table 23 and a molding table elevator 25. The molding container 21 has an opening in an upper surface. The molding table 23 is arranged in the molding container 21. The molding table elevator 25 vertically moves the molding table 23. In the present embodiment, the molding table elevator 25 is constituted by an electric actuator which is driven under the control of the control unit 50.

A base plate 27 is mounted on the upper surface of the molding table 23. A plurality of the objects 100, first support parts for coupling the objects 100 to each other and second support parts for coupling each object 100 and the base plate 27 are molded on the base plate 27. To be molded on the base plate 27 also means to be molded above the base plate 27 away from the upper surface of the base plate 28 besides being molded in contact with the upper surface of the base plate 27. The base plate 27 is, for example, formed of a steel material such as alloy steels including carbon steel and stainless steel. The base plate 27 may be, for example, formed of a metal material other than the steel material such as a titanium alloy instead of the steel material or may be formed of a ceramic material instead of the metal material.

The powder layer forming unit 30 includes a powder storage container 31, a powder extrusion table 33, a powder extrusion table elevator 35 and a recoater 37. The powder storage container 31 is arranged adjacent to the molding container 21. The powder storage container 31 has an opening in an upper surface. The powder extrusion table 33 is arranged in the powder storage container 31. The powder extrusion table elevator 35 vertically moves the powder extrusion table 33. In the present embodiment, the powder extrusion table elevator 35 is constituted by an electric actuator which is driven under the control of the control unit 50.

A metal powder PD used as a raw material of the objects 100 is stored in a space surrounded by the powder storage container 31 and the powder extrusion table 33. The kind of metal of the metal powder PD is, for example, an aluminum alloy. The kind of the metal of the metal powder PD may be, for example, a titanium alloy, a nickel alloy, a stainless steel, a maraging steel or the like instead of the aluminum alloy. The metal powder PD stored in the powder storage container 31 is extruded to an upper part of the powder storage container 31 by the ascent of the powder extrusion table 33.

The recoater 37 conveys the metal powder PD extruded to the upper part of the powder storage container 31 to the molding container 21 and flatly lays the metal powder PD on the base plate 27, thereby forming a powder layer PL made of the metal powder PD on the base plate 27. In the present embodiment, the recoater 37 is constituted by a squeegee and an electric actuator for moving the squeegee under the control of the control unit 50. It should be noted that the recoater 27 may be constituted by a roller and an electric actuator for moving the roller in another embodiment.

The laser emitting unit 40 includes a laser oscillator 41, an optical fiber 43 and a laser head 45. The laser oscillator 41 generates a laser beam IS. In the present embodiment, the laser beam LS is a fiber laser beam. It should be noted that the laser beam LS may be, for example, a solid-state laser beam other than the fiber laser beam such as a disk laser beam, a semiconductor laser beam or a YAG laser beam or may be, for example, a gas laser beam such as a carbon dioxide laser beam instead of the solid-state laser beam.

The laser head 45 is arranged above the molding container 21. The laser head 45 is connected to the laser oscillator 41 by the optical fiber 43. The laser head 45 emits the laser beam LS supplied from the laser oscillator 41 via the optical fiber 43 toward the powder layers PL. In the present embodiment, the laser head 45 includes a built-in Galvano scanner, and the laser head 45 moves an irradiation position of the laser beam LS along two axial directions parallel to a horizontal plane.

The control unit 50 is configured as a computer including a CPU, a memory and an input/output interface. In the present embodiment, the control unit 50 molds the objects 100 by controlling the molding table elevator 25, the powder extrusion table elevator 35, the recoater 37, the laser oscillator 41 and the laser head 45 as described later. It should be noted that the control unit 50 may be constituted by a combination of a plurality of circuits instead of the computer.

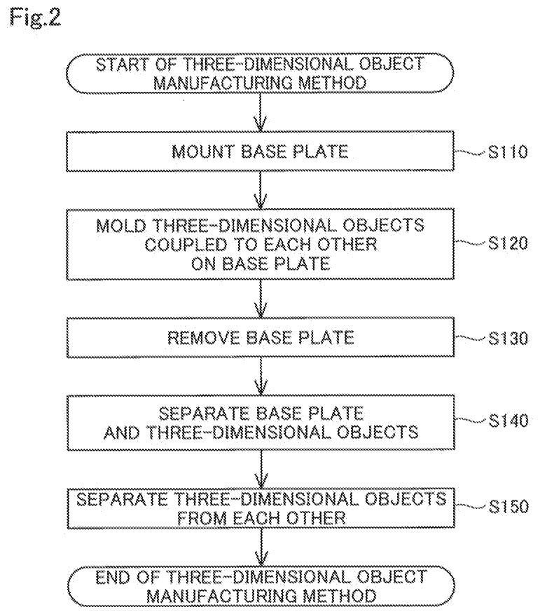

FIG. 2 is a flow chart showing contents of the method for manufacturing the objects 100 in the present embodiment. First, in Step S110, the base plate 27 is mounted on the upper surface of the molding table 23. Subsequently, in Step S120, the plurality of objects 100 having a desired shape and the first and second support parts are molded on the base plate 27 by the control unit 50 controlling each component of the additive manufacturing apparatus 10. In the following description, a processing of Step S120 is called a molding step. The molding step is described in detail later.

Thereafter, in Step S130, the base plate 27 is removed from the molding table 23. In Step S140, each object 100 is separated from the base plate 27. In Step S150, the objects 100 are separated from each other to complete each object 100. A processing from Step S140 to Step S150 is called a separation step. The separation step is described in detail later.

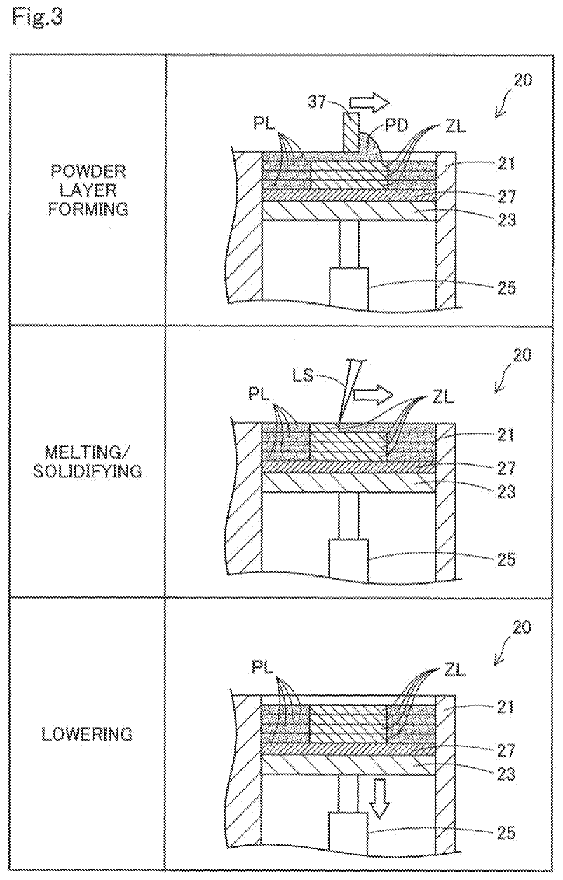

FIG. 3 is a diagram showing a state of the molding step in the present embodiment. In the present embodiment, the molding step includes a powder layer forming step, a melting/solidifying step and a lowering step. The molding step is performed under the control of the control unit 50.

First, in the powder layer forming step, the control unit 50 moves the powder extrusion table 33 upward and extrudes a predetermined amount of the metal powder PD from the powder storage container 31 by controlling the powder extrusion table elevator 35. The control unit 50 flatly lays the metal powder PD extruded from the powder storage container 31 on the base plate 27 to form the powder layer PL on the base plate 27 by moving the recoater 37.

Subsequently, in the melting/solidifying step, the control unit 50 irradiates a laser beam LS to a predetermined region on the powder layer PL to melt the powder layer PL in this region by controlling the laser oscillator 41 and the laser head 45. The melted powder layer PL is, for example, cooled and solidified for several seconds to become a molding layer ZL.

Thereafter, in the lowering step, the control unit 50 lowers the molding table 23 and the base plate 27 by a distance corresponding to a thickness of the molding layer ZL by controlling the molding table elevator 25. The control unit 50 stacks the molding layer ZL on the molding layer(s) ZL by repeating the powder layer forming step, the melting/solidifying step and the lowering step until the formation of all the molding layers ZL is finished, thereby molding the plurality of objects 100 and the first and second support parts.

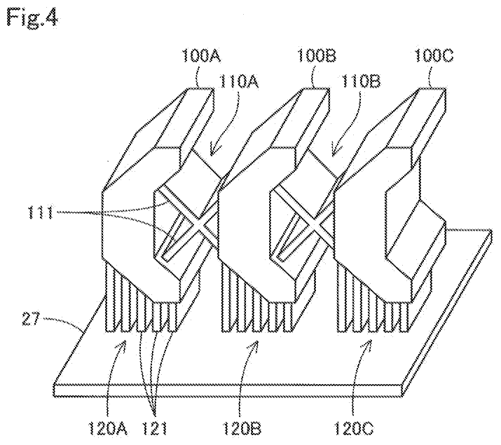

FIG. 4 is a perspective view showing an example of the plurality of objects 100 molded on the base plate 27. In an example shown in FIG. 4, three objects 100A to 100C are formed at mutually different positions on the base plate 27. The objects 100A to 100C have the same shape. In the following description, the object 100A may be called a first three-dimensional object 100A or first object 100A, the object 100B may be called a second three-dimensional object 100B or second object 100B and the object 100C may be called a third three-dimensional object 100C or third object 100C. When being described without being particularly distinguished, the objects 100A to 100C may be called the three-dimensional objects 100 or objects 100. It should be noted that the number of the objects 100 molded on the base plate 27 is not limited to three, but may be two, four or more. The objects 100A to 100C may have mutually different shapes.

In the example shown in FIG. 4, a first support part 110A for coupling the first and second objects 100A, 100B, a first support part 110B for coupling the second and third objects 100B, 100C, a second support part 120A for coupling the first object 100A and the base plate 27, a second support part 120B for coupling the second objects 100B and the base plate 27 and a second support part 1200 for coupling the third object 100C and the base plate 27 are molded on the base plate 27 besides the first, second and third objects 100A, 100B and 100C.

The objects 100A to 100C are arranged at a distance from each other. The first support part 110A is arranged between the first and second objects 100A, 100B, and the first support part 110B is arranged between the second and third objects 100B, 100C. In the present embodiment, each first support part 110A, 110B includes two first plate-like parts 111 provided to cross each other. Each first plate-like part 111 is in the form of a flat plate. The first support parts 110A, 110B are configured into an X shape when viewed in a direction parallel to the upper surface of the base plate 27. To suppress a reduction of material yield, the first support parts 110A, 110B are preferably arranged at positions where intervals between the objects 100A to 100C are narrow. It should be noted that the first support parts 110A, 110B may be configured into an X shape when viewed in a direction perpendicular to the upper surface of the base plate 27.

Each object 100A to 100C is arranged at a distance from the base plate 27. The second support part 120A is arranged between the first object 100A and the base plate 27, the second support part 120B is arranged between the second object 100B and the base plate 27 and the second support part 120C is arranged between the third object 100C and the base plate 27. Each second support part 120A to 120C supports the corresponding object 100A to 100C. In the present embodiment, each second support part 120A to 120C includes five second plate-like parts 121 provided in parallel to each other. Each second plate-like part 121 is in the form of a flat plate. It should be noted that the number of the second plate-like parts 121 is not limited to five and may be an arbitrary number. However, the number of the second plate-like parts 121 is preferably more than that of the first plate-like parts 11M.

Each first support part 110A, 110B has strength and rigidity to withstand the weight of each object 100A to 100C when the base plate 27 is inclined with respect to the horizontal plane. In the present embodiment, the strength and rigidity of each second support part 120A to 120C are higher than those of each first support part 110A, 110B. In the present embodiment, the control unit 50 makes an energy density of the laser beam LS for molding each object 100A to 100C and each second support part 120A to 120C higher than that of the laser beam LS for molding the first support parts 110A, 110B by controlling the laser emitting unit 40 in the molding step. For example, the control unit 50 sets the energy density of the laser beam LS for molding each first support part 110A, 110B to 80% of the energy density of the laser beam LS for molding each object 100A to 100C and each second support part 120A to 120C. As the energy density of the laser beam LS irradiated to the powder layers PL increases, a melting degree of the powder layers PL increases. As the melting degree of the powder layers PL increases, a clearance by unmelted parts is less likely to be formed. Thus, a density of the molding layers ZL increases.

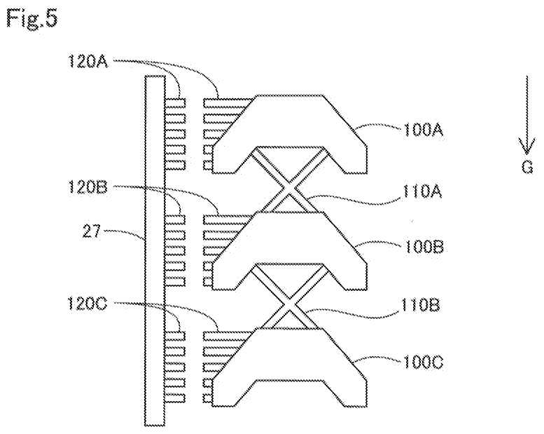

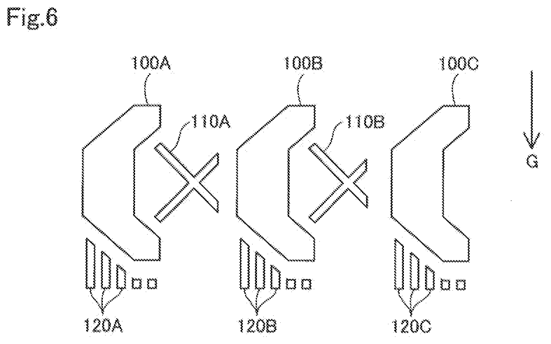

FIG. 5 is a first diagram showing a state of the separation step in the present embodiment. FIG. 6 is a second diagram showing a state of the separation step in the present embodiment. FIGS. 5 and 6 show a state where the three objects 100A to 100C shown in FIG. 4 are separated from each other.

In the present embodiment, each second support part 120A to 120C coupling each object 100A to 100C and the base plate 27 is first divided as shown in FIG. 5. By dividing each second support part 120A to 120C, each object 100A to 100C is separated from the base plate 27. In the present embodiment, each second support part 120A to 120C is divided by being cut by a contour machine (band saw). If each object 100A to 100C is separated from the base plate 27 with the base plate 27 facing upward, in other words, with a stacking direction of the objects 100A to 100C and a gravitational direction G set in parallel, there is a possibility that the objects 100A to 100C having lost support by the second support parts 120A to 1200 fall down and contact a blade of the contour machine. Accordingly, in the present embodiment, each object 100A to 100C is separated from the base plate 27 with the base plate 27 facing laterally, in other words, with the stacking direction of the objects 100A to 100C and the gravitational direction G set perpendicular to each other to prevent the contact of each object 100A to 100C with the blade of the contour machine.

Subsequently, as shown in FIG. 6, the first support parts 110A to 110B coupling the objects 100A to 100C to each other are divided with the stacking direction of the objects 100A to 1000 and the gravitational direction G set parallel to each other. For example, the first support parts 110A to 110B are divided, for example, by being cut by a nipper. The objects 100A to 100C are separated from each other by dividing the first support parts 110A, 110B.

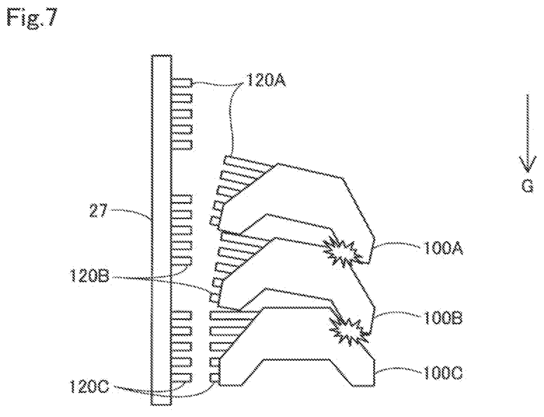

FIG. 7 is diagram showing a state of the separation step in a comparative example. In the comparative example, the first support parts 110A, 110B are not provided. When the first support parts 110A, 110B are not provided, there is a possibility that the objects 100A to 100C having lost support by the second support parts 120A to 120C fall down and contact each other to be broken as shown in FIG. 7 if the second support parts 120A to 120C are cut with the base plate 27 facing laterally. Even if the second support parts 120A to 120C are cut with the base plate 27 facing upward, there is a possibility that the objects 100A to 100C having lost support by the second support parts 120A to 120C fall over and contact each other to be broken. The mutual contact of the objects 100A to 100C can be avoided by inserting cushioning materials between the objects 100A to 100C. However, in the case of inserting the cushioning materials between the objects 100A to 100C, production efficiency is reduced since it takes effort and time to insert the cushioning materials. Further, it is difficult to insert the cushioning materials between the objects 100A to 100C if intervals between the objects 100A to 100C are narrow.

In contrast, according to the method for manufacturing the three-dimensional objects 100 in the present embodiment described above, the first support part 110A for coupling the first and second objects 100A, 100B and the first support part 110B for coupling the second and third objects 100B, 100C are molded in the molding step. Thereafter, in the separation step, the objects 100A to 100C are separated from each other by cutting each first support part 110A, 110B after each object 100A to 100C is separated from the base plate 27. Thus, the intervals between the objects 100A to 100C can be ensured by the first support parts 110A, 110B in separating each object 100A to 100C from the base plate 27. Therefore, it can be suppressed that each object 100A to 100C is damaged due to the mutual contact of the objects 100A to 100C in separating each object 100A to 100C from the base plate 27. Particularly, in the present embodiment, the mutual contact of the objects 100A to 100C can be suppressed in separating each object 100A to 100C molded by the additive manufacturing of the SLM type for irradiating the laser beam LS to the powder layers PL formed of the metal powder PD from the base plate 27.

Further, since the second support parts 120A to 120C for coupling each object 100A to 100C and the base plate 27 are molded in the molding step in the present embodiment, each object 100A to 100C can be supported by each second support part 120A to 120C. Thus, each object 100A to 100C can be molded with good dimensional accuracy by suppressing the collapse of the shape of each object 100A to 100C during the molding of each object 100A to 100C.

Further, since the rigidity of each second support part 120A to 120C is higher than that of each first support part 110A, 110B in the present embodiment, it is possible to suppress the deformation of each second support part 120A to 120C during the molding of each object 100A to 100C. Particularly, in the present embodiment, it is possible to suppress the deformation of each second support part 120A to 120C caused by the objects 100A to 100C pulling each other via each first support part 110A, 110B due to shrinkage when the melted powder layers PL are solidified.

Further, since the energy density of the laser beam IS for molding each second support part 120A to 1200 is higher than that of the laser beam LS for molding each first support part 110A, 110B in the present embodiment, the density of each second support part 120A to 1200 can made higher than that of each first support part 110A, 110B. Thus, each second support part 120A to 120C can made less deformable.

Further, since each first support part 110A, 110B includes two first plate-like parts 111 provided to cross each other in the present embodiment, the rigidity of each first support part 110A, 110B can be easily ensured. Thus, the mutual contact of the objects 100A to 100C due to the deformation of each first support part 110A, 10B can effectively suppressed in separating each object 100A to 100C from the base plate 27.

Further, in the present embodiment, each second support part 120A to 120C is constituted by a plurality of the second plate-like parts 121 and the number of the second plate-like parts 121 is more than that of the first plate-like part 111 of each first support part 110A, 110B. Thus, each second support part 120A to 120C can be made less deformable as compared to the case where the number of the second plate-like parts 121 of each second support part 120A to 1200 is equal to or less than that of the first plate-like part 111 of each first support part 110A, 110B.

### B. Second Embodiment

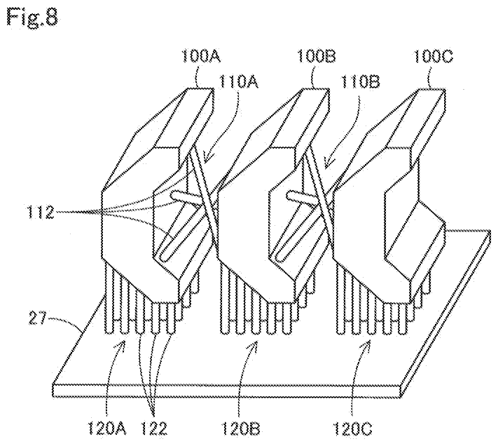

FIG. 8 is a perspective view showing an example of a plurality of objects 100 molded on a base plate 27 by a method for manufacturing three-dimensional objects 100 in a second embodiment. The second embodiment differs from the first embodiment in that each first support part 110A, 110B includes first rod-like parts 112 instead of the first plate-like parts 111 and each second support part 120A to 120C includes second rod-like parts 122 instead of the second plate-like parts 121. The other configuration is the same as in the first embodiment unless particularly described.

In the present embodiment, each first support part 110A, 110B includes three first rod-like parts 112 provided along mutually different directions. Each first rod-like part 112 is in the form of a straight rod. The first rod-like parts 112 are preferably arranged at mutually twisted positions. It should be noted that the number of the first rod-like parts 112 may be not three, but four or more. The first rod-like parts 112 may be arranged to cross each other or may be arranged in parallel to each other.

In the present embodiment, each second support part 120A to 120C includes twenty second rod-like parts 122 arranged perpendicular to the upper surface of the base plate 27. The second rod-like parts 122 are arranged in five columns and four rows on the base plate 27. Each second rod-like part 122 is in the form of a straight rod. The number of the second rod-like parts 122 may be an arbitrary number without being limited to twenty. However, the number of the second rod-like parts 122 is preferably more than that of the first rod-like parts 112.

According to the method for manufacturing the three-dimensional objects 100 in the present embodiment described above, the rigidity of each first support part 110A, 110B can be easily ensured since each first support part 110A, 110B includes the three first rod-like parts 112 provided along the mutually different directions.

Further, in the present embodiment, each second support part 120A to 120C is constituted by the plurality of second rod-like parts 122 and the number of the second rod-like parts 122 is more than the first rod-like parts 112 of each first support part 110A, 110B. Thus, each second support part 120A to 120C can be made less deformable as compared to the case where the number of the second rod-like parts 122 of each second support part 120A to 120C is equal to or less than that of the first rod-like parts 112 of each first support part 110A, 110B.

### C. Third Embodiment

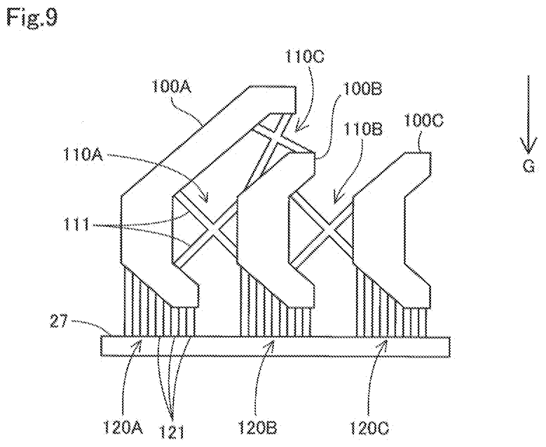

FIG. 9 is a side view showing an example of a plurality of objects 100 molded on a base plate 27 by a method for manufacturing three-dimensional objects 100 in a third embodiment. The third embodiment differs from the first embodiment in that a first object 100A and a second object 100B have parts overlapping each other when viewed in a stacking direction of the first and second objects 100A, 100B and a first support part 110C for coupling the first and second objects 100A, 100B is provided between the first and second objects 100A and 100B in the stacking direction. The other configuration is the same as in the first embodiment unless particularly described.

In the present embodiment, the first and second objects 100A, 110B are coupled to each other by a first support part 110A and the first support part 1100. The first support part 110C includes two first plate-like parts 111 provided to cross each other similarly to the first support part 110A. It should be noted that the first support part 110C may include three or more first rod-like parts 112 provided along mutually different directions.

In the present embodiment, in a separation step, the objects 100A to 100C are separated from each other by cutting each first support part 110A to 110C after each object 100A to 100C is separated from the base plate 27.

According to the method for manufacturing the three-dimensional objects 100 in the present embodiment described above, an interval between the first and second objects 100A, 100B in the stacking direction can be ensured by the first support part 110C even if the first and second objects 100A, 110.8 have the parts overlapping each other in the stacking direction.

### D. Other Embodiments

(D1) In the method for manufacturing the three-dimensional objects 100 in each of the embodiments described above, each object 100A to 100C, each first support part 110A to 110C and each second support part 120A to 120C are molded by the additive manufacturing of the SIM type for melting the powder layers PL by irradiating the laser beam LS to the powder layers PL, out of additive manufacturing of the powder bed fusion type. In contrast, each object 100A to 100C, each first support part 110A to 110C and each second support part 120A to 120C may be molded by an additive manufacturing of the SLS (Selective Laser Sintering) type for sintering the powder layers PL by irradiating a laser beam LS to the powder layers PL or may be molded by an additive manufacturing of the EMB (Electron Beam Melting) type for melting the powder layers PL by irradiating an electron beam to the powder layers PL, out of the additive manufacturing of the powder bed fusion type. Each object 100A to 100C, each first support part 110A to 1100 and each second support part 120A to 120C may be molded, for example, by an additive manufacturing of the FDM (Fused Deposition Modeling) type or of the optical molding type instead of the additive manufacturing of the powder bed fusion type. In the case of the additive manufacturing of the FDM type or optical molding type, not the metal material, but a resin material may be used as the raw material of each object 100A to 100C, each first support part 110A to 110C and each second support part 120A to 120C.

(D2) In the method for manufacturing the three-dimensional objects 100 in each of the embodiments described above, in the separation step, the objects 100A to 100C are separated from each other by cutting each first support part 110A to 100C after each object 100A to 100C is separated from the base plate 27. In contrast, in the separation step, the second object 100B may be separated from the base plate 27 after the first object 100A is separated from the base plate 27 and the first and second objects 100A 100B are separated by cutting the first support part(s) 110A, 110C. Thereafter, the third object 100C may be separated from the base plate 27 after the second object 100B is separated from the base plate 27 and the second and third objects 100B, 100C are separated by cutting the first support part 110B. Even in this case, the mutual contact of the objects 100A to 100C can be suppressed in separating each object 100A to 100C from the base plate 27. Note that the order of separating each object 100A to 100C from the base plate 27 is not limited to the aforementioned order. For example, the objects 100A to 1000 may be separated in the order of the third object 100C, the second object 100B and the first object 100A or in the order of the first object 100A, the third object 100C and the second object 100B.

(D3) In the method for manufacturing the three-dimensional objects 100 in each of the embodiments described above, the second support parts 120A to 120C are molded between each object 100A to 100C and the base plate 27. In contrast, the second support parts 120A to 120C may not be molded between each object 100A to 100C and the base plate 27, and each object 100A to 100C may be provided with a predetermined cutting margin and molded in contact with the base plate 27.

(D4) In the method for manufacturing the three-dimensional objects 100 in each of the embodiments described above, the rigidity of each second support part 120A to 120C is higher than that of each first support part 110A to 110C. In contrast, the rigidity of each second support part 120A to 1200 may be equal to or less than that of each first support part 110A to 110C. In this case, the rigidity of each second support part 120A to 120C is preferably equal to that of each first support part 110A to 110C.

(D5) In the method for manufacturing the three-dimensional objects 100 in each of the embodiments described above, the energy density of the laser beam LS for molding each second support part 120A to 120C is higher than that of the laser beam LS for molding each first support part 110A to 110C. In contrast, the energy density of the laser beam LS for molding each second support part 120A to 120C may be equal to or lower than that of the laser beam LS for molding each first support part 110A to 110C. In this case, the energy density of the laser beam LS for molding each second support part 120A to 120C is preferably equal to that of the laser beam LS for molding each first support part 110A to 110C.

(D6) In the method for manufacturing the three-dimensional objects 100 in each of the embodiments described above, the control unit 50 sets the energy density of the laser beam LS for molding each second support part 120A to 120C higher than that of the laser beam LS for molding each first support part 110A to 110C in the melting/solidifying step of the molding step. In contrast, the control unit 50 may not change the energy density of the laser beam LS in the melting/solidifying step. In this case, the control unit 50 may, for example, irradiate the laser beam LS for two layers each time instead of irradiating the laser beam LS for each layer to mold the first support parts 110A to 110C. By this method, the density of each first support part 110A to 110C can be made lower than that of each second support part 120A to 120C.

(D7) In the method for manufacturing the three-dimensional objects 100 in each of the first and third embodiments described above, each first support part 110A to 110C is constituted by the plurality of first plate-like parts 111 and each second support part 120A to 120C is constituted by the plurality of second plate-like parts 121. In contrast, each first support part 110A to 110C may be constituted by the plurality of first plate-like parts 111 and each second support part 120A to 120C may be constituted by the plurality of second rod-like parts 122. Alternatively, each first support part 110A to 110C may be constituted by the plurality of first rod-like parts 112 and each second support part 120A to 120C may be constituted by the plurality of second plate-like parts 121.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, a three-dimensional object manufacturing method is provided. This three-dimensional object manufacturing method includes a molding step of molding a first three-dimensional object, a second three-dimensional object and a first support part for coupling the first and second three-dimensional objects at mutually different positions on a base plate by an additive manufacturing, and a separation step of separating the first three-dimensional object, the second three-dimensional object, the first support part and the base plate from each other. In the separation step, the first and second three-dimensional objects are separated from each other by dividing the first support part after at least one of the first and second three-dimensional objects is separated from the base plate.

According to the three-dimensional object manufacturing method of this form, an interval between the first and second three-dimensional objects can be ensured by the first support part. Thus, it is possible to suppress the damage of the first and second three-dimensional objects due to the mutual contact of the first and second three-dimensional objects in separating the first and second three-dimensional objects from the base plate.

(2) In the three-dimensional object manufacturing method of the above form, in the separation step, the first and second three-dimensional objects may be separated from each other by dividing the first support part after the first and second three-dimensional objects are separated from the base plate.

According to the three-dimensional object manufacturing method of this form, the mutual contact of the first and second three-dimensional objects can be suppressed in separating the first and second three-dimensional objects from the base plate.

(3) In the three-dimensional object manufacturing method of the above form, in the separation step, the second three-dimensional object may be separated from the base plate after the first three-dimensional object is separated from the base plate and the first and second three-dimensional objects are separated by dividing the first support part.

According to the three-dimensional object manufacturing method of this form, the mutual contact of the first and second three-dimensional objects can be suppressed in separating the first and second three-dimensional objects from the base plate.

(4) In the three-dimensional object manufacturing method of the above form, the molding step may include a powder layer forming step of forming a powder layer by laying a metal powder on the base plate and a melting/solidifying step of melting the powder layer by irradiating a beam to a predetermined region of the powder layer and solidifying the melted powder layer, and the first three-dimensional object, the second three-dimensional object and the first support part may be molded at mutually different positions on the base plate by repeatedly performing the powder layer forming step and the melting/solidifying step.

According to the three-dimensional object manufacturing method of this form, the mutual contact of the first and second three-dimensional objects can be suppressed in separating the first and second three-dimensional objects molded by irradiating the beam to the powder layer formed by the metal powder from the base plate.

(5) In the three-dimensional object manufacturing method of the above form, a second support part for coupling the first three-dimensional object and the base plate may be molded in the molding step.

According to the three-dimensional object manufacturing method of this form, it is possible to suppress the collapse of the shape of the first three-dimensional object during the molding of the first three-dimensional object since the first three-dimensional object is supportable by the second support part.

(6) In the three-dimensional object manufacturing method of the above form, the rigidity of the second support part may be higher than that of the first support part.

According to the three-dimensional object manufacturing method of this form, it is possible to suppress the collapse of the shape of the first three-dimensional object due to the deformation of the second support part during the molding of the first three-dimensional object since the second support part can be made less deformable.

(7) In the three-dimensional object manufacturing method of the above form, the first support part may include a plurality of first plate-like parts provided to cross each other.

According to the three-dimensional object manufacturing method of this form, the mutual contact of the first and second three-dimensional objects can be effectively suppressed in separating the first and second three-dimensional objects from the base plate since the rigidity of the first support part can be easily ensured.

(8) In the three-dimensional object manufacturing method of the above form, a second support part for coupling the first three-dimensional object and the base plate may be molded in the molding step, the second support part may include a plurality of second plate-like parts, and the number of the second plate-like parts may be more than that of the first plate-like parts.

According to the three-dimensional object manufacturing method of this form, it is possible to suppress the collapse of the shape of the first three-dimensional object due to the deformation of the second support part during the molding of the first three-dimensional object since the second support part may be made less deformable as compared to the case where the number of the second plate-like parts is equal to or less than that of the first plate-like parts.

(9) In the three-dimensional object manufacturing method of the above form, the first support part may include three or more first rod-like parts provided along mutually different directions.

According to the three-dimensional object manufacturing method of this form, the mutual contact of the first and second three-dimensional objects can be effectively suppressed in separating the first and second three-dimensional objects from the base plate since the rigidity of the first support part can be easily ensured.

(10) In the three-dimensional object manufacturing method of the above form, a second support part for coupling the first three-dimensional object and the base plate may be molded in the molding step, the second support part may include a plurality of second rod-like parts, and the number of the second rod-like parts may be more than that of the first rod-like parts.

According to the three-dimensional object manufacturing method of this form, it is possible to suppress the collapse of the shape of the first three-dimensional object due to the deformation of the second support part during the molding of the first three-dimensional object since the second support part can be made less deformable as compared to the case where the number of the second rod-like parts is equal to or less than that of the first rod-like parts.

(11) In the three-dimensional object manufacturing method of the above form, a second support part for coupling the first three-dimensional object and the base plate may be molded in the molding step, and an energy density of the beam for molding the second support part may be higher than that of the beam for molding the first support part.

According to the three-dimensional object manufacturing method of this form, the second support part can be made less deformable since the density of the second support part can be higher than that of the first support part.

(12) In the three-dimensional object manufacturing method of the above form, the first and second three-dimensional objects may have parts overlapping each other when viewed in a stacking direction of the first and second three-dimensional objects, and the first support part may be provided between the first and second three-dimensional objects in the stacking direction.

According to the three-dimensional object manufacturing method of this form, the mutual contact of the first and second three-dimensional objects can be effectively suppressed in separating the first and second three-dimensional objects molded to have the parts overlapping each other when viewed in the stacking direction of the first and second three-dimensional objects from the base plate.

The present disclosure is realizable in various forms other than the three-dimensional object manufacturing method. For example, the present disclosure is realizable by an additive manufacturing, a additive manufacturing apparatus, a control method of the additive manufacturing apparatus and the like.

What is claimed is:

1. A three-dimensional object manufacturing method, comprising:
molding a first three-dimensional object, a second three-dimensional object and a first support part for coupling the first and second three-dimensional objects at mutually different positions on a base plate by an additive manufacturing; and
separating the first three-dimensional object, the second three-dimensional object, the first support part and the base plate from each other;
wherein the separating separates the first and second three-dimensional objects from each other by dividing the first support part after separating at least one of the first and second three-dimensional objects from the base plate.

2. The three-dimensional object manufacturing method according to claim 1, wherein:
the separating separates the first and second three-dimensional objects from each other by dividing the first support part after separating the first and second three-dimensional objects from the base plate.

3. The three-dimensional object manufacturing method according to claim 1, wherein:
the separating separates the second three-dimensional object from the base plate after separating the first three-dimensional object from the base plate and separating the first and second three-dimensional objects by dividing the first support part.

4. The three-dimensional object manufacturing method according to claim 1, wherein:
the molding includes forming a powder layer by laying a metal powder on the base plate, melting the powder layer by irradiating a beam to a predetermined region of the powder layer, and solidifying the melted powder layer, and
the first three-dimensional object, the second three-dimensional object and the first support part are molded at mutually different positions on the base plate by repeatedly performing the forming, the melting, and the solidifying.

5. The three-dimensional object manufacturing method according to claim 1, wherein:
the molding molds a second support part for coupling the first three-dimensional object and the base plate.

6. The three-dimensional object manufacturing method according to claim 5, wherein:
the rigidity of the second support part is higher than that of the first support part.

7. The three-dimensional object manufacturing method according to claim 1, wherein:
the first support part includes a plurality of first plate-like parts provided to cross each other.

8. The three-dimensional object manufacturing method according to claim 7, wherein:
the molding molds a second support part for coupling the first three-dimensional object and the base plate,
the second support part includes a plurality of second plate-like parts, and
the number of the second plate-like parts is more than that of the first plate-like parts.

9. The three-dimensional object manufacturing method according to claim 1, wherein:
the first support part includes three or more first rod-like parts provided along mutually different directions.

10. The three-dimensional object manufacturing method according to claim 9, wherein:
the molding molds a second support part for coupling the first three-dimensional object and the base plate,
the second support part includes a plurality of second rod-like parts, and
the number of the second rod-like parts is more than that of the first rod-like parts.

11. The three-dimensional object manufacturing method according to claim 4, wherein:
the molding molds a second support part for coupling the first three-dimensional object and the base plate, and
an energy density of the beam for molding the second support part is higher than that of the beam for molding the first support part.

12. The three-dimensional object manufacturing method according to claim 1, wherein:
the first and second three-dimensional objects have parts overlapping each other when viewed in a stacking direction of the first and second three-dimensional objects, and
the first support part is provided between the first and second three-dimensional objects in the stacking direction.
